(19) United States
(12) Patent Application Publication
(10) Pub. No.: US 2011/0095636 A1
(43) Pub. Date: Apr. 28, 2011

(54) MAGNETIC FORCE BASED AUTOMATIC POWER GENERATION DEVICE

(76) Inventor: CHIU-FA LEE, Tucheng City (TW)

(21) Appl. No.: 12/606,203

(22) Filed: Oct. 27, 2009

(51) Int. Cl. H02K 47/14; H02K 53/00

(52) U.S. Cl. 310/113; 415/916

(57) ABSTRACT

A magnetic force based automatic power generation device includes a ring body, which has an inner circumference along which spaced permanent magnets are arranged and an outer circumference along which spaced electric magnets are arranged. A driving element is coupled to a top of the ring body. A speed reduction device is coupled to a bottom of the ring body. The speed reduction device is coupled to a power generation element. By starting the ring body by means of the electric magnets and the permanent magnets, the ring body is allowed to be continuously driven by alternating magnetic attractive and repulsive forces induced between magnetic poles of the permanent magnets and the electric magnets and a driving force generated by the driving element for fast rotation, which in turn drives the speed reduction device and the power generation element, so that the power generation device is caused to generate electricity.

### (a) TECHNICAL FIELD OF THE INVENTION

The present invention generally relates to a magnetic force based automatic power generation device, and more particularly to a magnetic force based automatic power generation device that realizes high efficiency power generation through low energy consumption.

### (b) DESCRIPTION OF THE PRIOR ART

With continuous consumption of the energy resources of the Earth, energy crises continuously emerge. For this reason, most countries of the world are spending a great amount of labors and resources in the development of new energies and substitute energies. One of the solutions that is commonly referred to is perpetual-machine power generation. Up to date, this idea never succeeds and no practical perpetual machine has been developed and created. One of the reasons is that there is no way to maintain constant rotation or operation of the perpetual machine without intervention of external forces and thus, the perpetual-machine power generation never becomes a useful and new substitute energy source. In view of this, the present invention aims to provide a power generation device that realizes high efficiency power generation through low consumption of energy.

### SUMMARY OF THE INVENTION

The primary objective of the present invention is to provide a magnetic force based automatic power generation device, which realizes high efficiency power generation through starting and maintaining the operation of a power generation device in a low energy consumption manner, and thus realizing environmental protection and energy conservation.

In accordance with the present invention, a magnetic force based automatic power generation device is provided, comprising a ring body, which has an inner circumference along which spaced permanent magnets are arranged and an outer circumference along which spaced electric magnets are arranged. A driving element is coupled to a top of the ring body. A speed reduction device is coupled to a bottom of the ring body. The speed reduction device is coupled to a power generation element. By starting the ring body by means of the electric magnets and the permanent magnets, the ring body is allowed to be continuously driven by alternating magnetic attractive and repulsive forces induced between magnetic poles of the permanent magnets and the electric magnets and a driving force generated by the driving element for fast rotation, which in turn drives the speed reduction device and the power generation element, so that the power generation device is caused to generate electric power, wherein a small fraction of the power so generated is applied back to the driving element to maintain the rotation of the ring body and a major portion of the power generated is supplied from the power accumulator to an external electric appliance to be consumed thereby so as to realize power generation of low energy consumption and high efficiency.

In the magnetic force based automatic power generation device discussed above, the driving element coupled to the top of the ring body comprises a low power motor.

In the magnetic force based automatic power generation device discussed above, the power generation element coupled to the bottom of the ring body comprises a dynamo.

The foregoing objectives and summary provide only a brief introduction to the present invention. To fully appreciate these and other objects of the present invention as well as the invention itself all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic view of the present invention in an assembled form.

FIG. 2 is a schematic exploded view of the present invention.

FIG. 3 is a schematic view of a ring body of the present invention.

FIG. 4 demonstrates the operation of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

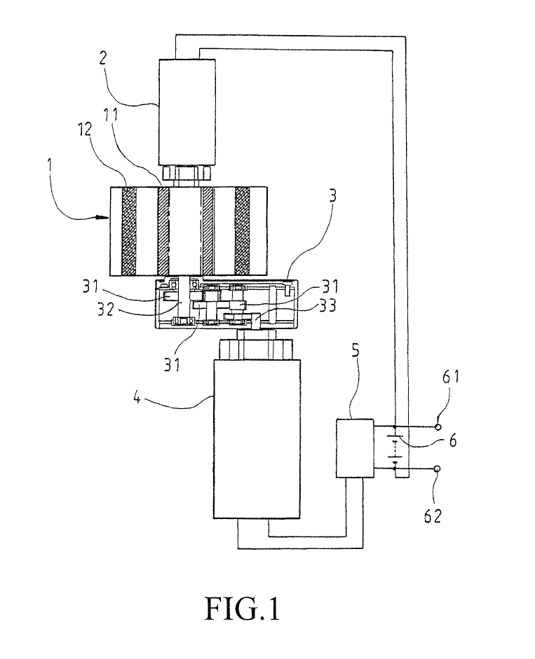

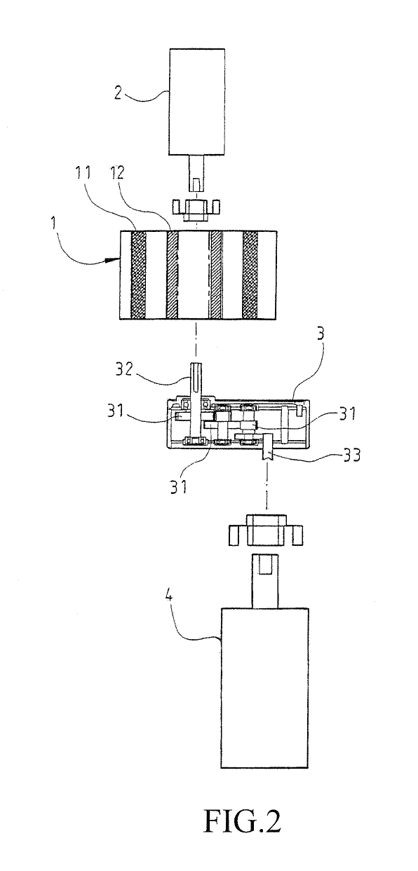

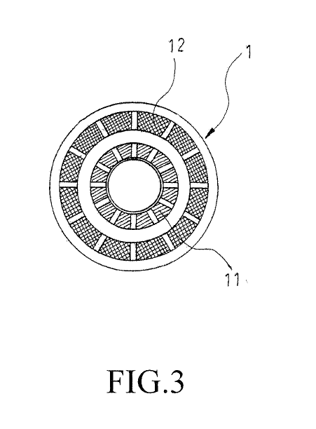

Referring to FIGS. 1 and 2, which respectively show a schematic view of the present invention in an assembled form and a schematic exploded view of the present invention, and FIG. 3, which shows a schematic view of a ring body of the present invention, as shown in the drawings, the present invention comprises a ring body 1 that comprises a plurality of permanent magnets 11 arranged in a spaced manner along an inner circumference thereof and a plurality of electric magnets 12 arranged in a spaced manner along an outer circumference of the ring body 1.

A driving element 2, which in the instant embodiment comprises a low power motor, is coupled to a top of the ring body 1 so that the driving element 2 is coupled to an upper central hole of the ring body 1.

A speed reduction device 3 is coupled to a bottom of the ring body 1 and the speed reduction device 3 comprises a plurality of mated gears 31 that is coupled to a lower central hole of the ring body 1 through an output shaft 32.

A power generation element 4, which in the instant embodiment comprises a dynamo, is coupled to a gear shaft 33 of the speed reduction device 3.

A rectification and voltage regulation device 5 is connected to the power generation element 4 and is also connected to a power accumulator 6, which is connected to the driving element 2.

Through properly assembling the above discussed components/devices, a magnetic force based automatic power generation device is provided. The magnetic forced based power generation device is operated by starting the ring body 1 by means of the electric magnets and the permanent magnets to have the ring body 1 continuously driven by the alternating magnetic attractive and repulsive forces induced between magnetic poles of the permanent magnets 11 and the electric magnets 12 and the driving force generated by the driving element 2 for fast rotation, which in turn drives the speed reduction device 3 and the power generation element 4, whereby the power generation device 4 is caused to generate electric power and the power is conducted through the rectification and voltage regulation device 5 for rectification and regulation of voltage of the electric power for eventual storage in the power accumulator 6. A small fraction of the power so generated is applied back to the driving element 2 to maintain the continuous rotation of the ring body 1 and to maintain the alternating attraction and repulsion between the magnetic poles of the permanent magnets 11 and the electric magnets 12. A major portion of the power generated is supplied through terminals 61, 62 of the power accumulator 6 to an external electric appliance to be consumed thereby. Thus, power generation of low energy consumption and high efficiency is realized.

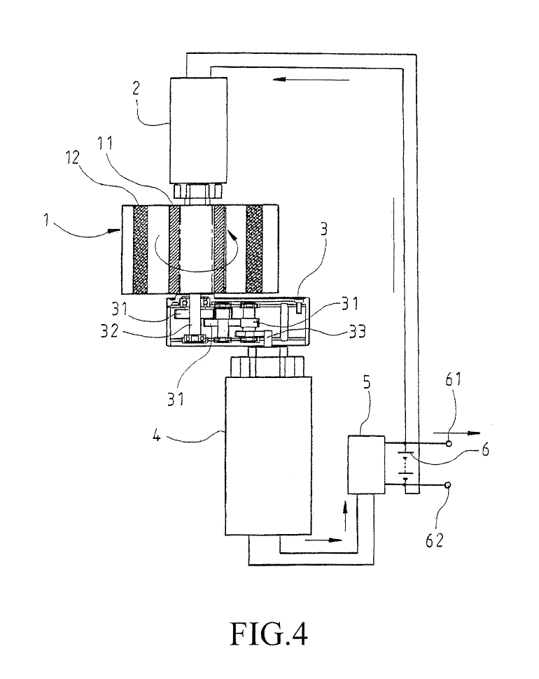

Referring to FIG. 4, which demonstrates the operation of the present invention, as shown, to operate the present invention, the ring body 1 is started by means of the electric magnets and the permanent magnets in such a way that the permanent magnets 11 of the ring body 1 are rotated circumferentially with respect to the electric magnets 12 to repeatedly and alternately induce magnetic attraction and repulsion between the magnetic poles of the two kinds of magnets. During the repeated induction of magnetic attraction and repulsion, the ring body 1 is provided with kinetic energy generated by the mutual-driving occurring between the permanent magnets 11 and the electric magnets 12 and the driving operation by the driving element 2, so that the ring body 1 can maintain fast and continuous rotation.

When the ring body 1 is put in rotation, the ring body 1 continuously drives the speed reduction device 3, so as to induce a transformed speed in the speed reduction device 3, whereby the speed reduction device 3 can drive the power generation element 4 with a proper speed to make the power generation element 4 generating electric power, which is then subjected to rectification and voltage regulation by the rectification and voltage regulation device 5 to be accumulated in the power accumulator 6.

After being accumulated in the power accumulator 6, a small fraction of the power is fed back to the driving element 2 to maintain the continuous rotation of the ring body 1 and thus maintain the alternating magnetic attraction and repulsion between the magnetic poles of the permanent magnets 11 and the electric magnets 12. A major portion of the power generated is supplied through the terminals 61, 62 of the power accumulator 6 to an external electric appliance to be consumed thereby. Thus, high efficiency power generation by the power generation element 4 can be realized with low energy consumption by the driving element 2. Accordingly, energy conservation and environmental protection can be realized.

To summarize, the present invention realizes high efficiency power generation, and thus environmental protection and energy conservation, through starting and maintaining the operation of a power generation device in a low energy consumption manner by providing a magnetic force based automatic power generation device that comprises properly assembled driving element and power generation element, together with a ring body carrying magnets.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A magnetic force based automatic power generation device, comprising:
a ring body, which has an inner circumference along which a plurality of permanent magnets is arranged in a spaced manner and an outer circumference along which a plurality of electric magnets is arranged in a spaced manner;
a driving element, which is coupled to a top of the ring body;
a speed reduction device, which is coupled to a bottom of the ring body; and
a power generation element, which is coupled to the speed reduction device;
whereby a magnetic force based automatic power generation device is realized through assembling of the components, wherein by starting the ring body by means of the electric magnets and the permanent magnets, the ring body is allowed to be continuously driven by alternating magnetic attractive and repulsive forces induced between magnetic poles of the permanent magnets and the electric magnets and a driving force generated by the driving element for fast rotation, which in turn drives the speed reduction device and the power generation element, so that the power generation device is caused to generate electric power to be accumulated in a power accumulator, wherein a small fraction of the power so generated is applied back to the driving element to maintain the rotation of the ring body and a major portion of the power generated is supplied from the power accumulator to an external electric appliance to be consumed thereby so as to realize power generation of low energy consumption and high efficiency.

2. The magnetic force based automatic power generation device according to claim 1, wherein the driving element coupled to the top of the ring body comprises a low power motor.

3. The magnetic force based automatic power generation device according to claim 1, wherein the power generation element coupled to the bottom of the ring body comprises a dynamo.

4. The magnetic force based automatic power generation device according to claim 1, wherein the speed reduction device comprises a plurality of mated gears, an output shaft, and a gear shaft, the power shaft being coupled to the ring body, the gear shaft being coupled to the speed reduction device.

5. The magnetic force based automatic power generation device according to claim 1, wherein the power generation element is coupled to a rectification and voltage regulation device, which is in turn connected to the power accumulator, the power accumulator being connected to the driving element, whereby electric power generated by the power generation element is subjected to rectification and voltage regulation by the rectification and voltage regulation device to be accumulated in the power accumulator, from which a small fraction of the power is fed back to the driving element to maintain the rotation of the ring body and a major portion of the power is supplied to the external electric appliance to be consumed thereby.
